(19) United States
(12) Patent Application Publication
(10) Pub. No.: US 2008/0067257 A1
(43) Pub. Date: Mar. 20, 2008

(54) Marking and Reading System

(75) Inventor: Jon Kristian Hagene, Dilling (NO)

Correspondence Address: YOUNG & THOMPSON, 745 SOUTH 23RD STREET, 2ND FLOOR, ARLINGTON, VA, 22202, US

(73) Assignee: NORSK ELEKTRO OPTIKK AS, LORENSKOG (NO)

(21) Appl. No.: 11/629,675

(22) PCT Filed: Jul. 1, 2005
(86) PCT No.: PCT/NO05/00247

§ 371 Date: Dec. 15, 2006

(51) Int. Cl. G06K 19/06

(52) U.S. Cl. 235/494

(57) ABSTRACT

An electrode for use in industrial processes is provided with a mark. The marking apparatus comprises an information unit for providing a mark (110) representing some form of information relating to the electrode (100). The mark is arranged as a part of the electrode. A corresponding electrode mark reading apparatus for providing information related to an electrode includes a radiation unit for directing radiation towards the electrode, a detection unit for detecting radiation reflected by or transmitted through at least a part of the electrode, and for converting the detected radiation into a converted signal. A decoding unit is adapted to transform the converted signal into a decoded signal. A part of the decoded signal is related to a mark on the electrode. Conversion elements for converting the decoded signal into an electrode code is provided for obtaining code representing a feature related to the electrode.

This invention is related to electrodes being used primarily in electrochemical industries.

In particular this invention is related to electrodes which are replaced at regular intervals after they are worn out.

### BACKGROUND OF THE INVENTION

In electrochemical industry aluminium smelters are normally equipped with reduction cells having cathodes and anodes, generally called electrodes. Electrical current is applied to the reduction cells and an electrolytic process takes place which produces an end product, such as for example aluminium.

Typically, the electrodes will be replaced at regular intervals, as the wear out after some time, depending on the quality of the electrode and other process parameters. In some cases it has been experienced that individual electrodes or batches of electrodes have unexpectedly short life cycles. It is known that electrode anomalies may lead to unwanted incidents in the reduction cells, such as for example explosions or fragmentation of the electrode.

Until now it has been difficult to keep trace of the different electrode parts in order to enable a better identification of which electrodes fails and in order to improve the quality control of the processes involved in the manufacturing of such electrodes.

Each electrode is made by the mixing of ingredients, which subsequently is vibration formed into its desired shape. The electrode is then baked in a baking furnace at high temperatures together with numerous other electrodes. After the baking process, the electrodes are either stored or shipped to other sites where they can be either stored or equipped with an aluminium rod with stubs that makes it possible to connect the electrode to power.

### PRIOR ART

It is common practice to uniquely identify vehicles and other objects by attaching number plates or the like so that the authorities can trace the owner and possible driver. Attaching machine-readable marks to objects makes it possible to trace units during transportation, production or to charge an updated price in a shop as well as decrement the number available on stock.

Machine-Readable Marks or Codes

Barcodes on products in supermarkets and other shops are probably the most common machine-readable mark or code in everyday use. Several standards for barcodes exist. U.S. Pat. No. 3,632,995 (Wilson) describes a coding system printed onto coupons or labels utilising two tracks on the coupon, one track for “clock” and the other track for “data”. U.S. Pat. No. 4,263,504 (Thomas/NCR Corp.) describes a two dimensional machine-readable matrix-type code where each column in the code mark represents a letter or character. FIG. 2 in U.S. Pat. No. 4,562,343 (Wiik et. al./Trio Ving) shows a key card using punched holes as a binary code and where the binary code is used by the lock to grant or deny access to a hotel room. U.S. Pat. No. 4,734,565 (Pierce, Buxton/Drexler) describes a read-only optical card system with embedded optical codes in a card. U.S. Pat. No. 4,939,354 (Priddy et. el./Datacode international Inc.) describes a dynamically variable machine readable binary code system where it is possible to change the size and format of the code mark. Two sides of the rectangle consist of continuous lines while the two other consist of an intermittent square-no square pattern. This configuration allows for figuring out the size of the marks as well as its size in x times y squares. This code is known as “Data Matrix 2D” Barcode in the market and appears to be used by the US Department of Defence as a standard for marking parts.

Reading Devices for Reading Machine-Readable Code Marks

U.S. Pat. No. 5,463,213 (Takafaru Honda) describes a code mark reader system based on a standard IR electronic camera comprising an IR LED illumination system as well as two lasers to detect whether the marked object has the correct distance to the camera to obtain correct focus. This system is optimised for reading small engraved or oxidised marks on medical equipment where it is essential to get a contrast between areas that are engraved (or oxidised) and areas that are not (polished metal).

Devices for Creating Code Marks on Objects

U.S. Pat. No. 6,527,193 (Béli et. al./Hungarian state-railways) describes a mark generator based on changing the surface structure using energy and in particular using an “energy beam” like a laser. According to this patent the mark could also be created using a “heat removal” device that could also change the surface structure. This is probably based on stamping hot metal using a cold metal stamp. Moreover this prior patent describes a code mark reader based on a magnetic energising unit utilising magnetic flux to read marks on (ferrous) metals. The same patent also mentions ultra sound to read marks created by changing the surface structure of the metal as mentioned above.

Patent publication WO 94/11146 (Lappalainen et. al/Partec Cargotec) describes a laser based system for marking metal surfaces using laser pulses only changing surface colour with a minimum of metal evaporation. These marks are suitable for optical reading.

U.S. Pat. No. 6,315,801 (Dai Nippon Printing Co Ltd) describes a method of printing terminals and (code) marks onto electrode plates used in rechargeable batteries.

US patent application 2004/0058238 A1 (Miller/Wilson Greatbatch Tech.) describes a battery system that includes battery electrodes that could be marked with an ID mark that is possibly etched into the electrode surface. One etch method mentioned is “laser etching”. The batteries could also be used in medical applications like pace makers and similar devices.

None of the prior art publications or patents referred to above relate to the marking of anything similar to the industrial electrodes being of interest to the present invention. This also applies to U.S. Pat. No. 6,527,193 that in a general way may seem to relate to various kind of products or objects. However, neither this nor the other prior art patent publications present solutions that may be useful in connection with electrodes for use in electrochemical or electrometallurgical industries. The conditions and problems encountered in connection with such electrodes, will be understood from the present description.

### OBJECT OF THE INVENTION

It is thus an object of the invention to provide solutions which will enable tracing and gathering of information related to individual electrode parts in order to improve the possibilities for understanding and identifying possible causes of electrode malfunction and thereby enable improve the quality and reliability of the electrode parts.

### THE INVENTION

In a first aspect this invention relates to an electrode for use in industrial electrochemical or electrometallurgical processes and being typically during manufacturing subjected to heat treatment, and being adapted to be consumed during use. According to the invention the electrode is provided with a code pattern marking comprising at least one surface topology element in the form of a recess and/or protrusion in a surface portion of the electrode, for representing information relating to the electrode. Thus, topology elements in this connection may be in the form of recesses, indentations or holes. In the following description the term hole has been used to a large extent to designate the topology elements. On the other hand the inverse of a recess or indentation, namely a protrusion may constitute a topology element in this context. Protrusions may be more particularly in the form of studs or bulges or similar shapes.

The invention also comprises a method of such marking of electrodes.

According to a further aspect of the invention the above objective is obtained with an encoding and marking apparatus for providing an electrode for use in industrial processes with a mark. The encoding and marking apparatus comprises an information unit for providing a mark representing some form of information relating to said electrode, where said mark is to be placed on said electrode and a marking device for providing the electrode with said mark.

In another aspect of the invention the objectives are achieved by an electrode mark reading apparatus, for providing information related to an electrode. The reading apparatus has a radiation unit for directing radiation towards said electrode, and a detection unit for detecting radiation reflected by or transmitted through at least a part of said electrode, and for converting said detected radiation into a converted signal. A decoding unit is adapted to transform said converted signal into a decoded signal, a part of which is related to a mark on said electrode. Conversion means for converting said decoded signal into an electrode code obtains a code representing a feature related to said electrode.

In connection with the above, the invention may be considered to provide a code system for representing electrode information having an electrode surface portion with a mark section. The mark section comprises at least one submark relating to information associated with said electrode.

The objective is also achieved in yet another aspect of the invention, an electrode information system for an electrode for use in industrial processes, comprising an encoding and marking device for providing said electrode with an electrode specific mark, and a mark reading and decoding device for identifying possible mark(s) on said electrode. In addition an association module associates said mark(s) with electrode specific information and thereby creates a link between said mark(s) and information related to said electrode.

In a further aspect the objective set forth above is also achieved according to the invention with an electrode mark reading device for obtaining information related to an electrode comprising an imaging unit for obtaining an image of at least a part of said electrode and a decoding unit adapted to transform said image into a decoded signal, a part of which is related to a mark on said electrode. Conversion means are provided for converting said decoded signal into an electrode code, said electrode code representing a feature related to said electrode thus being made readily available.

In yet a further aspect the above objective is achieved by an electrode mark reading device for obtaining information related to an electrode comprising an imaging unit for obtaining an image of at last a part of said electrode, and a code interpretation unit for interpreting said image in order to find and interpret marks in a mark section on said at least part of said electrode which appear on said image, and to obtain a code representing said mark section.

The invention will now be described in more detail with reference to the appended drawings where

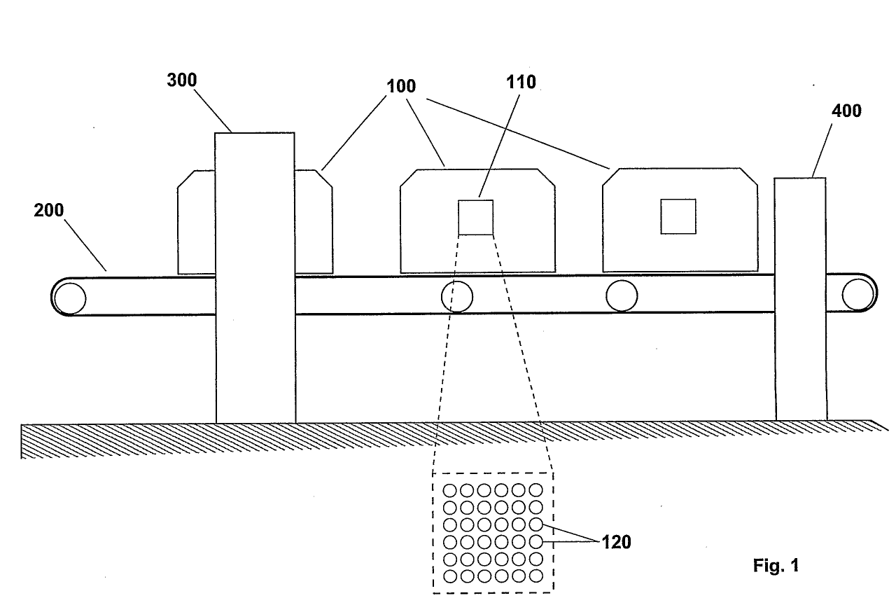

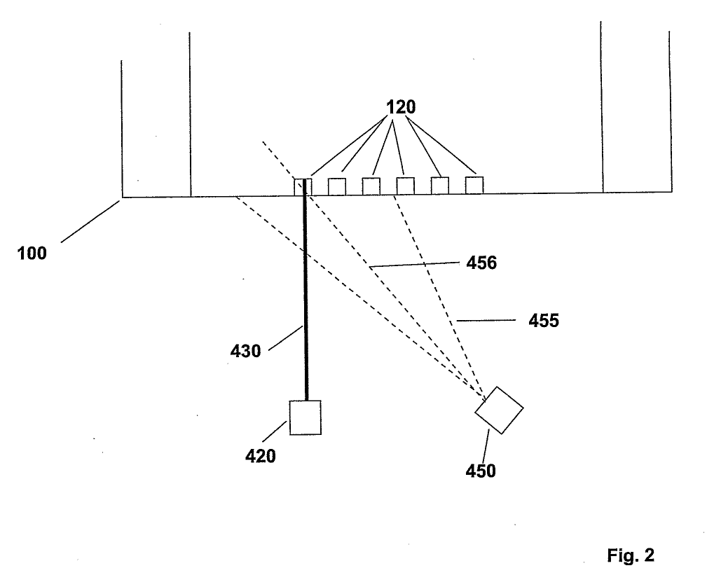

FIG. 1 illustrates an electrode conveyor belt, an electrode marking device and an electrode mark reading device.

FIG. 2 shows a top view of an electrode and the main parts of the electrode mark reading device.

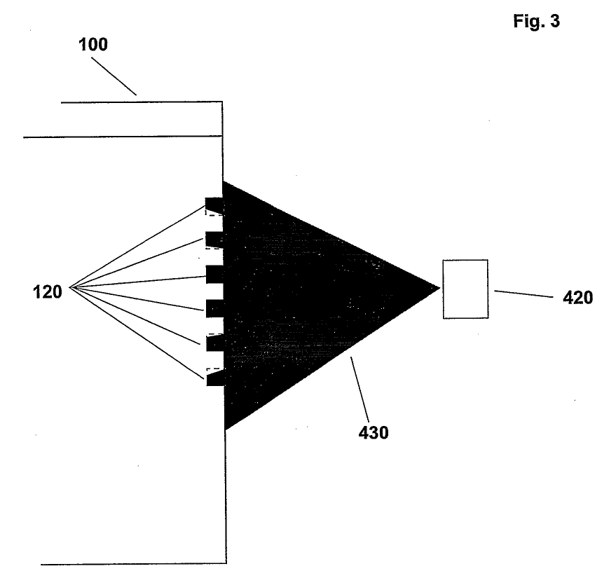

FIG. 3 illustrates an electrode and a light source with a fan shaped beam as seen from a side.

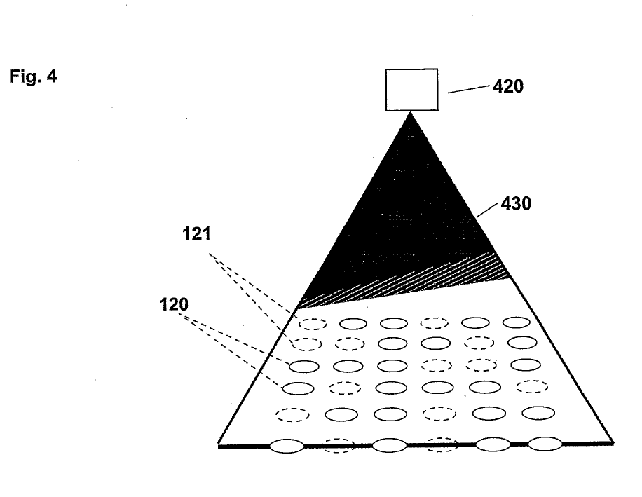

FIG. 4 shows the appearance of the light beam from the light source from the point of view of the cameras.

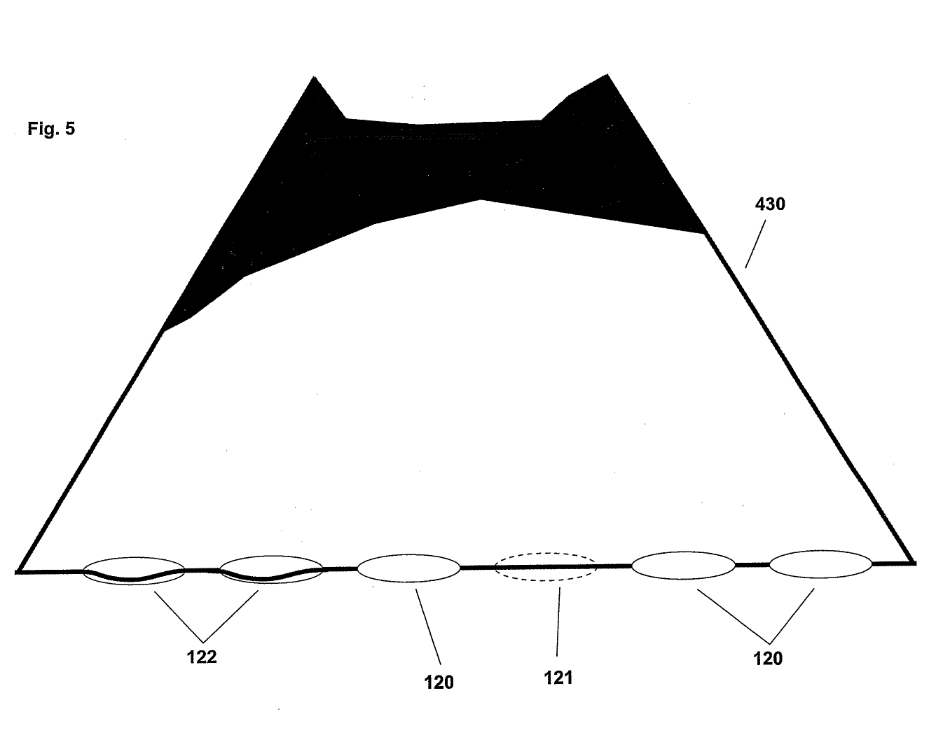

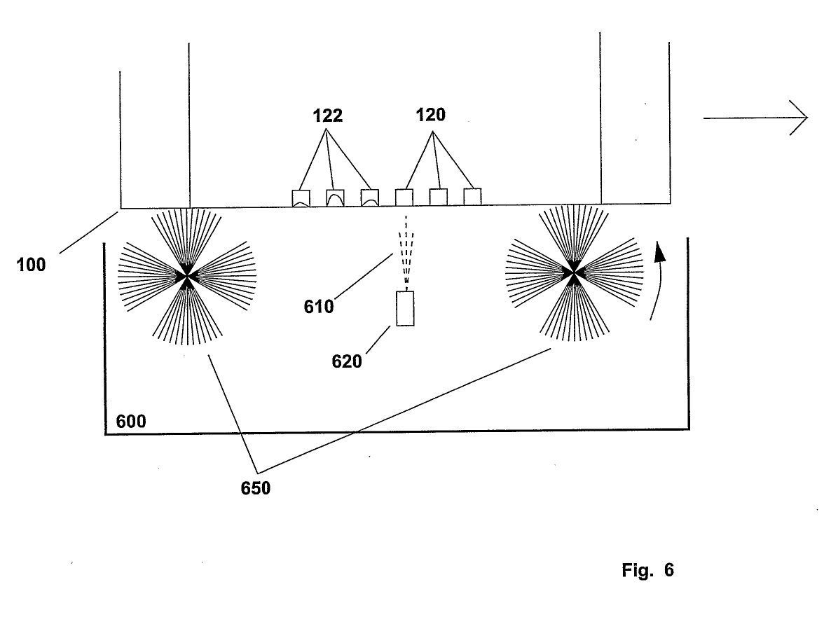

FIG. 5 illustrates the fan shaped line of light as seen from the point of view of the camera.

FIG. 6 illustrates electrode hole cleaning means.

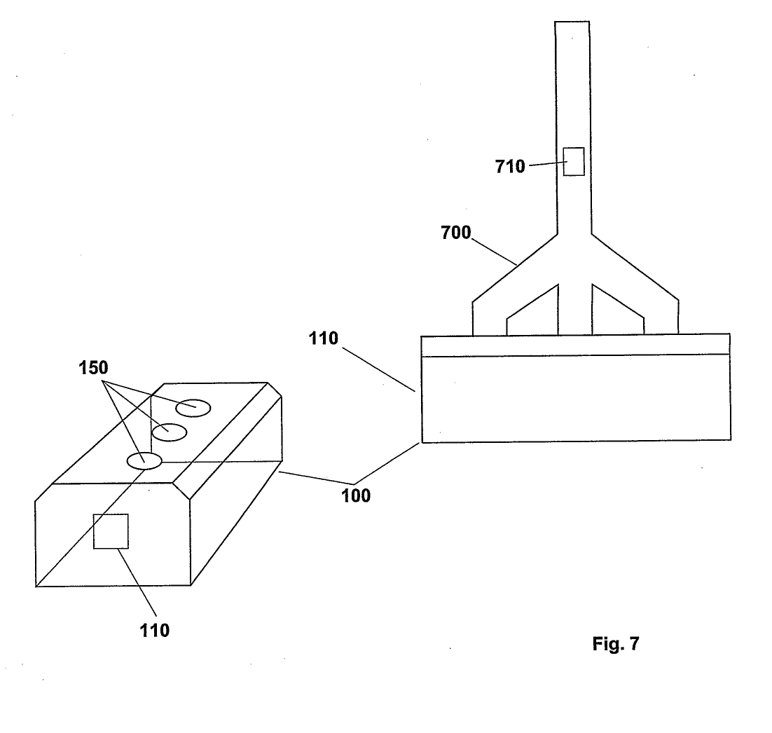

FIG. 7 shows an electrode with holes for a mounting rod.

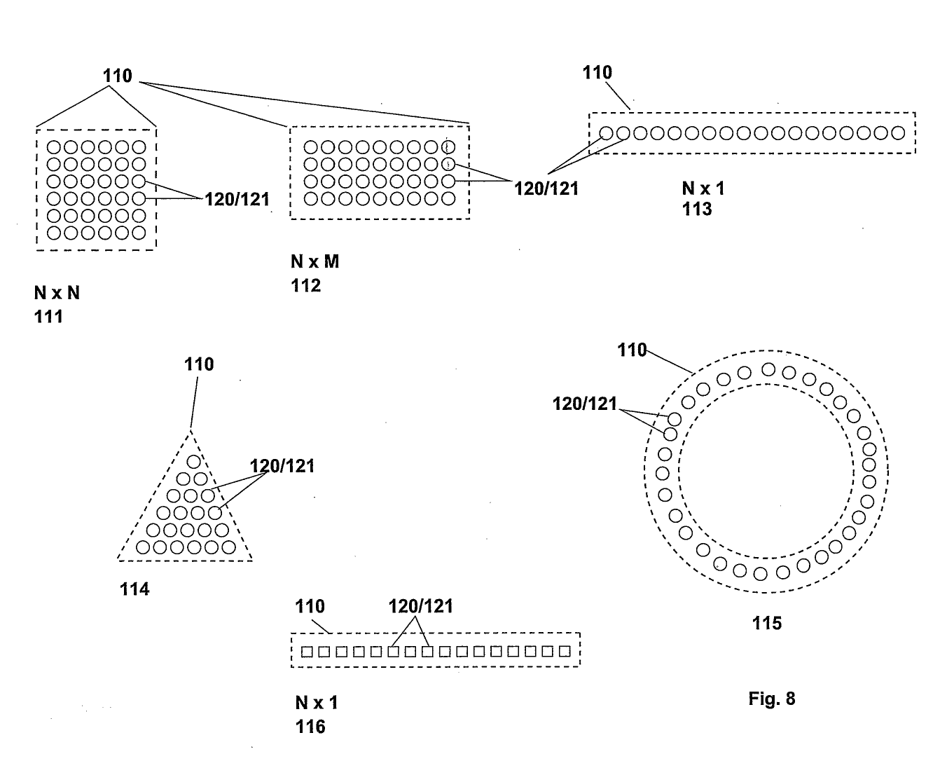

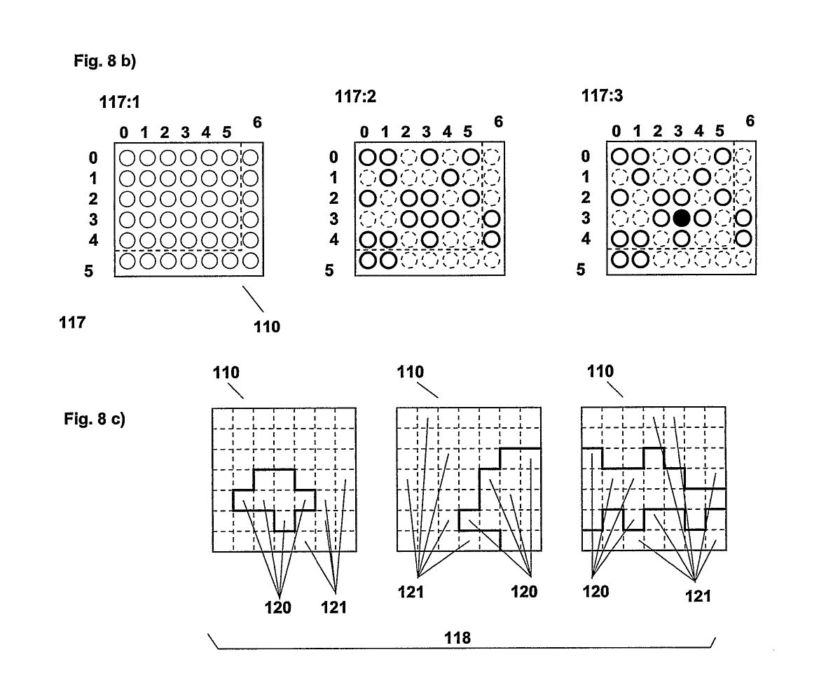

FIG. 8a shows different configurations of the electrode code.

FIG. 8b illustrates one example of a code scheme used in this invention to enable code fault detection and correction.

FIG. 8c illustrates one example of a code scheme used in this invention where all holes are adjacent.

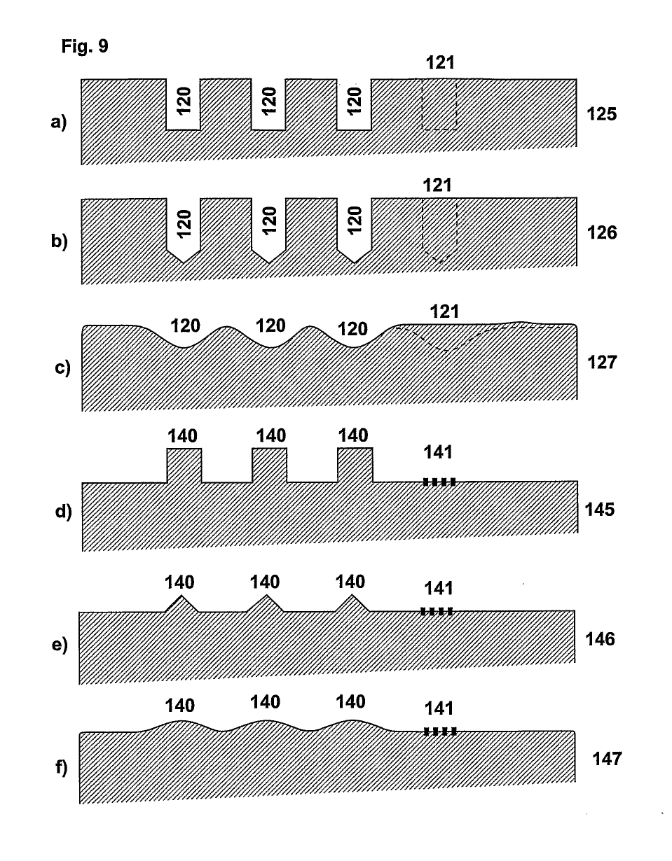

FIG. 9 shows different configurations of electrode holes and protrusions.

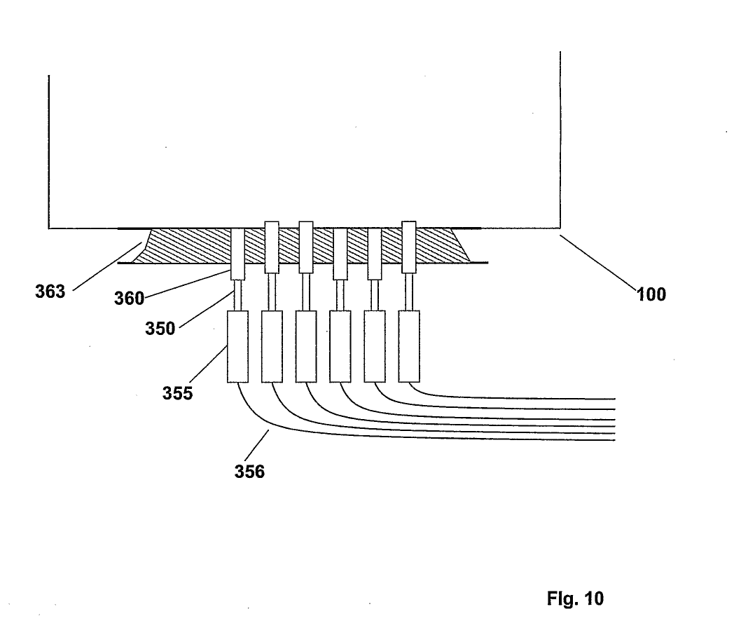

FIG. 10 shows parts of an electrode marking device based on pistons forced into the electrode in the moulding or vibration forming process.

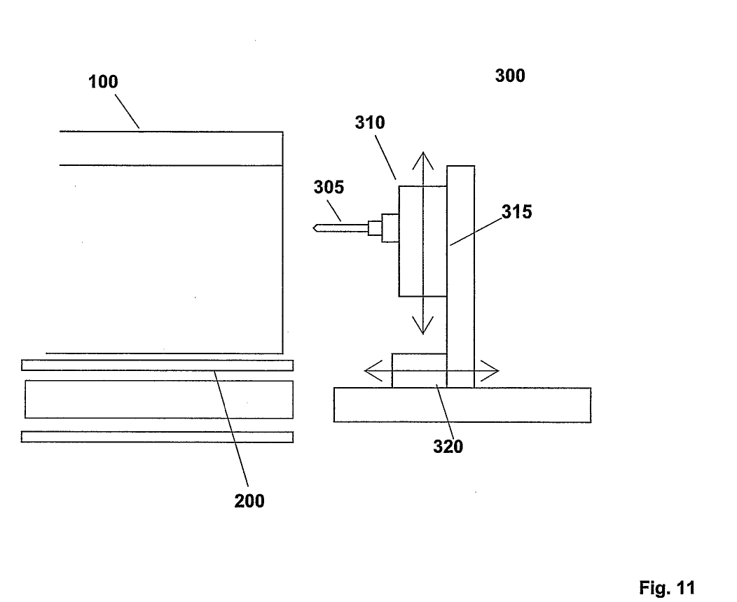

FIG. 11 shows a first embodiment of an electrode marking apparatus according to the invention.

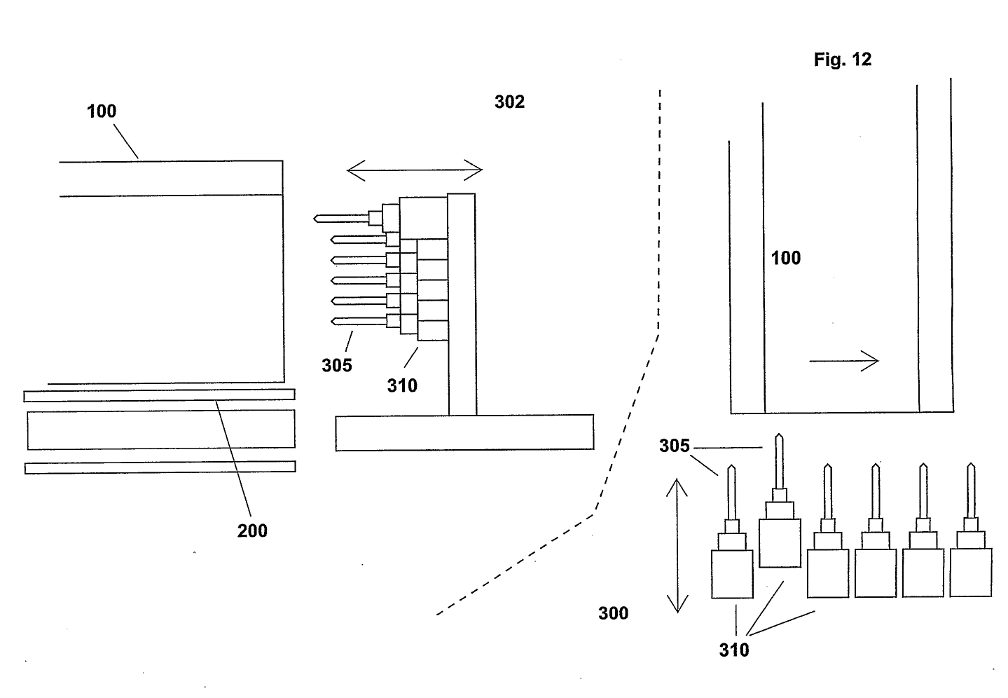

FIG. 12 shows a second embodiment of an electrode marking apparatus according to the invention.

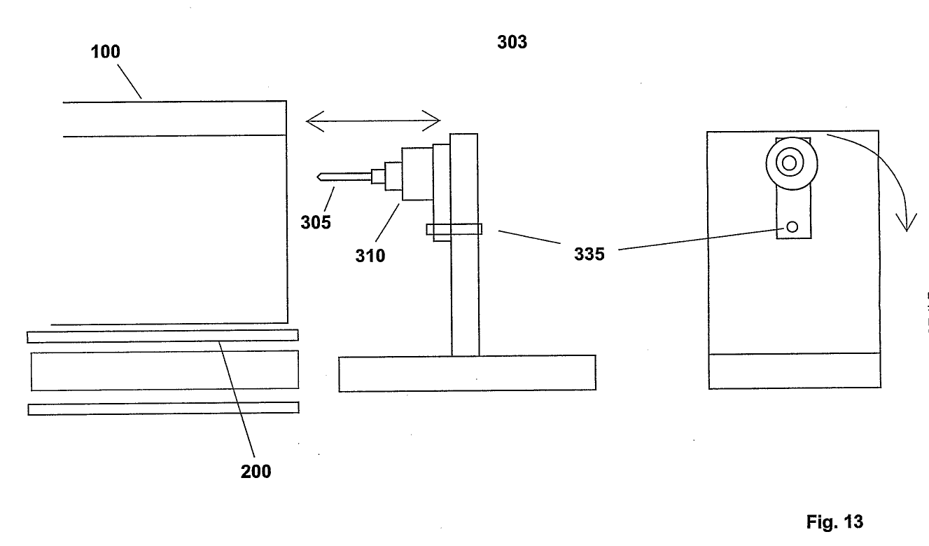

FIG. 13 illustrates a third embodiment of an electrode marking device apparatus according to the invention.

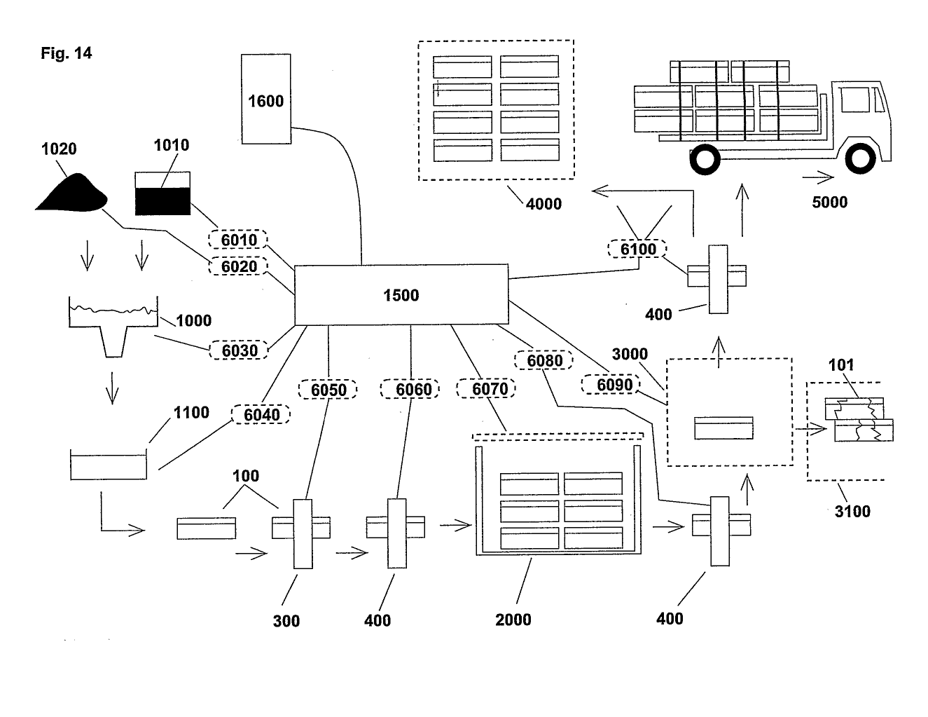

FIG. 14 shows a schematic diagram of the production flow in an electrode manufacturing plant.

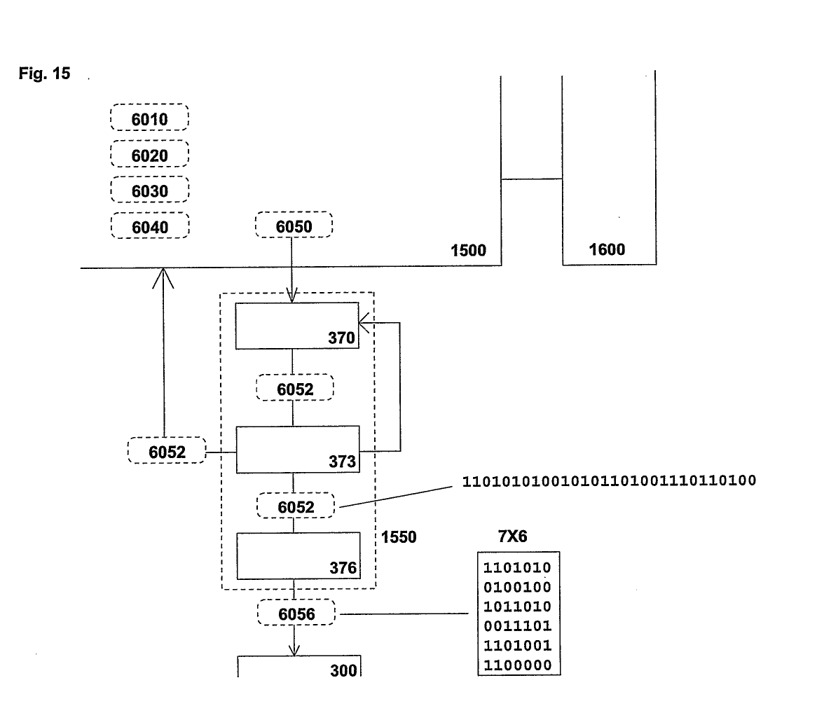

FIG. 15 illustrates the control and database system of this invention, in particular the encoding and mark system.

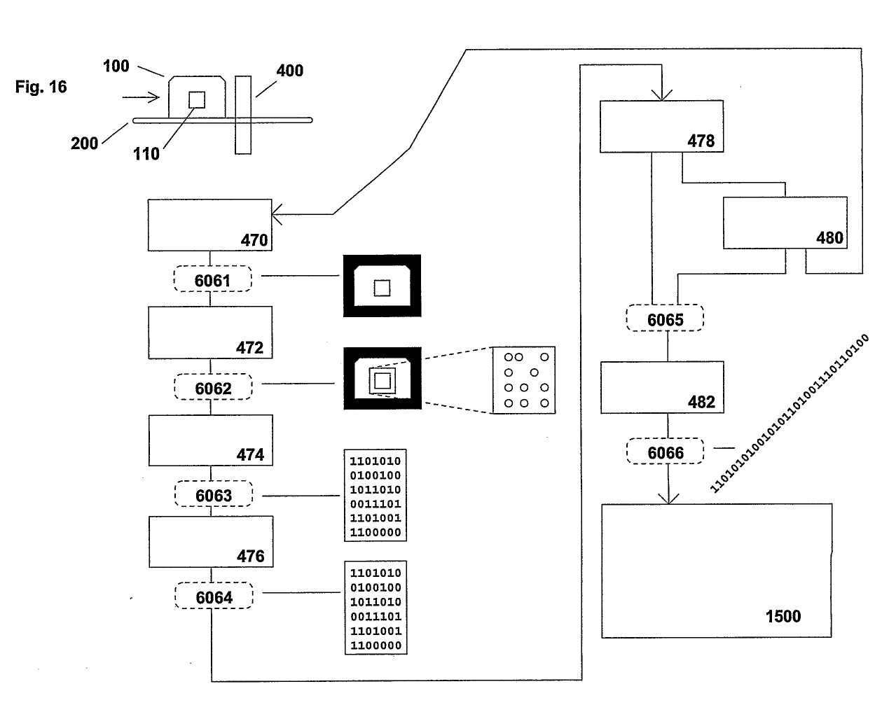

FIG. 16 shows the details of the reader and decoder system that typically will be part of the reader or part of the control and database system of the invention.

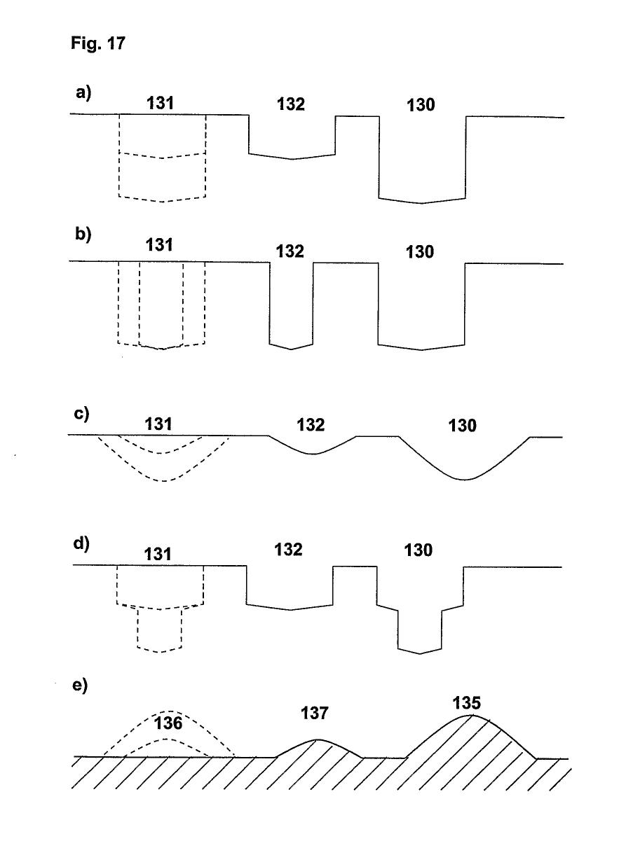

FIG. 17a-e schematically shows a multilevel digital code mark system based on recesses or holes and protrusions, respectively.

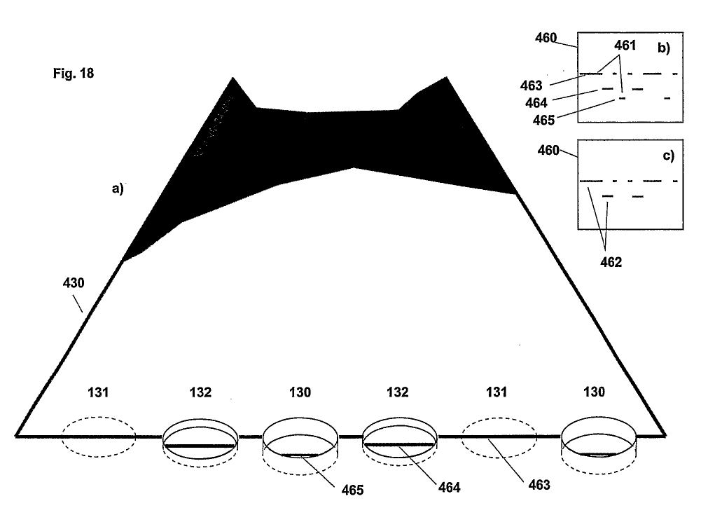

FIG. 18 somewhat more in detail illustrates imaging as indicated in FIGS. 2-5, using height information with respect to holes of varying depth.

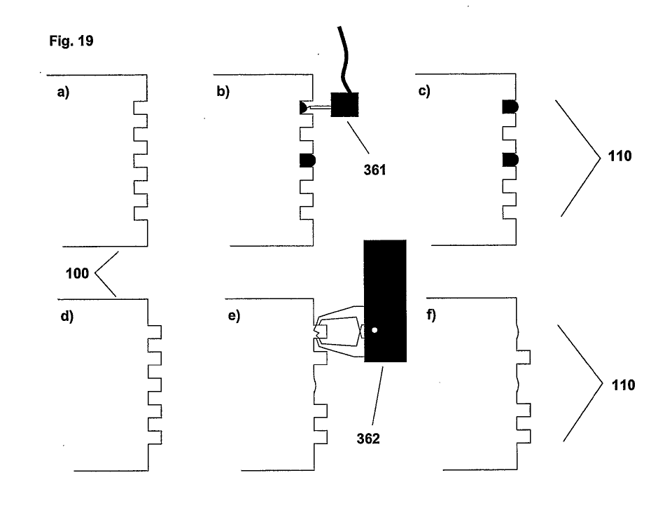

FIG. 19 illustrates specific methods of forming code pattern markings based on recesses and protrusions, respectively.

The core of the invention rests on the concept of providing each electrode with a unique code when or after being vibration formed and preferably before any baking process, and an apparatus for reading this mark at any later stage of manufacturing or use of the electrode. For the purposes of this description the term “electrode” should be construed to mean any type of anode or cathode part being used in the electrochemical or electrometallurgical industry. An encoding and marking device thus provides an electrode for use in industrial processes with a mark 110,120. See FIG. 1. The encoding and marking device comprises an information unit for providing a mark representing information in some form relating to the electrode. An electrode marking device 300 provides the electrode itself with the mark supplied by the information unit.

The encoding and marking apparatus comprises a marking device 300 which can be any form of electrode surface altering device for modifying at least parts of the surface of said electrode with respect to structure, texture or topology, i.e a modification which may be detected by optical, acoustic or electromagnetic methods.

Each unique code is stored in a database system together with process data and complete specification and origin for the basic ingredients used in the process. Time and date for all events from forming to baking are stored as well as position in the baking furnace. All process parameters for the baking process parameters for the baking process related to each individual electrode are also stored in the database. This could include temperature gradients and profiles, gas composition depicting the combustion process.

Such data are important as the quality and origin of the raw materials like petrol coke and binder pitch used in the manufacture of the electrodes as well as the mixing process could influence on the quality of individual and batches of electrodes. Additives may also be added to improve the properties of the electrodes. Petrol coke, binder pitch and possibly additives are put into a mixer. The resulting mix is put into a preform (vibration former) where the electrodes are pressurised and vibrated in order to give them the right shape.

The encoding and marking device would in one example be equipped with a mark generating unit for generating a mark based on some of the above mentioned information or any other information related to said electrode that is available. A mark storage unit could be included for storing information relating to a plurality of marks.

The encoding and marking device can further be adapted with a rule storage unit for storing a set of predetermined rules that can be used for selecting, retrieving or generating said mark based on said information.

In a similar way the baking process in e.g. a baking furnace will influence the quality of electrodes. The baking furnace is divided in chambers or sections which are also divided into subchambers or subsections (pits). There are baking furnaces which are closed and some which are open. The position in the furnace (section, pits), temperature levels and gradients, temperature profile, combustion process, fuels and etc are thus important para-meters to include in such a database system. The baking furnace is often fuelled by the burning of injected oil. The supply of oxygen etc. will also contribute to the resulting burning. Measurements of temperature and contents of oxygen and carbon oxides may provide an image of the process.

After the baking process all transportation and storage steps are registered and stored in the database. In addition a quality control may be done in order to discard electrodes of resulting inferior quality. Those electrodes that are accepted in the quality control may be surface treated, e.g. coated or impregnated, in order to better withstand corrosion by O₂ and CO₂ during use in the cell. Information on the unique electrode and current conducting rod and stubs are stored when the rod is attached.

The next step in the life cycle of the electrode is the use of the electrode in the reduction cell. An ID of the cell and a position in the cell are now registered for each electrode. When the electrode is removed from the cell, most of it will have eroded and the identification must be based on either the position in the pot or on the number on the aluminium rod. Final information from the electrode will be stored in the database system at removal of the electrode. The remains of the electrode could possibly be recycled and information on the recycling could possibly also be stored in the database system.

Based on the data used in this invention it will be possible to correlate raw materials and process parameters during fabrication of the electrode to usability in the pot room as well as to unexpected incidents in the melting process.

FIG. 1 illustrates how electrodes 100 could be transported by a conveyor belt 200. An electrode marking device 300 is arranged at the conveyor belt 200. The electrodes 100 include an electrode mark region 110, which could be either a surface area or a volume region. The marking device 300 is adapted to provide the electrodes 100 with an electrode mark within the mark region 110. The electrode mark provided by the marking device 300 could cover substantially the whole of the mark region 100 or it could be in the form of one or more submarks 120 covering only a part of the mark region 100.

In a preferred embodiment of the invention the mark area 110 will consist of a plurality of submarks 120 in the form of hole locations where a physical hole or indentation is in fact present or where a hole or indentation has not yet been created. The combination of holes or indentations in the mark region will correspond to a unique numerical code that uniquely identifies the marked object. FIG. 1 also illustrates how a mark reading device 400 could be arranged at the conveyor belt 200. The electrode marking device 300 and the mark reading device 400 could be arranged next to, along, generally around or anywhere along the conveyor belt 200.

The invention also provides an electrode mark reading apparatus for providing information related to an electrode. A radiation unit 420 is arranged for directing radiation towards said electrode. The radiation unit 420 could be adapted to project a collimated beam of light onto the electrode, for example by using a collimated source of light. In one embodiment of the invention the radiation unit 420 is adapted to provide a beam of radiation having a generally spot shaped cross section, with a largest cross sectional dimension being smaller than an opening diameter of a recess defined by said mark on the electrode, in order that the whole or major part of the beam of radiation is incident on or impinges on said electrode generally or substantially inside said recess. In one embodiment, the radiation unit 420 comprises a laser source. A detection unit 450 is arranged for detecting radiation reflected by or transmitted through at least a part of said electrode 100, and for converting said detected radiation into a converted signal. The radiation unit 420 could comprise an electromagnetic radiation source or an acoustic radiation source. The radiation unit 420 would in one example of the invention be adapted to provide a fan shaped beam of radiation directed towards the electrode 100.

A decoding unit is adapted to transform said converted signal into a decoded signal, a part of which is related to a mark on said electrode. The decoding unit will typically be a part of a computer based control and database system 1500.

A conversion unit provides means for converting said decoded signal into an electrode code, thus obtaining code representing a feature related to said electrode. This conversion unit would also typically be a part of the computer based control and database system 1500.

The electrode mark reading device has a camera, example with functionality for obtaining a two-dimensional image, in one embodiment the camera has a two-dimensional sensor. The camera is directed towards the electrode for providing two-dimensional images of the surface of the electrode. The abovementioned decoding unit can be adapted to process two-dimensional images of the electrode surface. In another embodiment of the invention the camera has a one-dimensional camera for obtaining a one-dimensional image of the radiated area of the electrode.

The reading apparatus preferably comprises means to measure the relative velocity of reader device versus the electrode. This will give a better aspect ratio for images acquired by the camera part and making the signal processing easier. This could compensate for varying velocity in particular if the mark reading apparatus is a portable one. Depending on the mark reader type, portable or for fixed mounting, the means for measuring the velocity could be based on angular velocity or spatial velocity.

FIG. 2 shows a top view of an electrode 100 and the main parts 420,430,450 of a mark reading device 400. If optical technology is being used the means for radiation would typically be a light source 420, for example a laser diode or an LED (Light Emitting Diode), emitting light towards the electrode 100, preferably in the form of a fan of light 430 creating an illuminated stripe when projected onto the electrode 100. A camera 450 depicts the area on the electrode 100 that is illuminated by the light source. The camera field of view 455 is indicated on FIG. 2. A hole or indentation in the electrode being hit by the fan of light 430 could be made so deep that the walls of the hole generally obstructs all or most of the light reflected from that part of the surface of the electrode. The dashed line 456 in FIG. 2 indicates a camera direction in which the camera will “see” a generally dark part of the surface or in other words a dark hole or indentation.

International Patent Application PCT/NO03/00110 to the present applicant, published as WO 03/089833, is hereby included by reference. WO 03/089833 describes an inspection apparatus for the interior inspection of pipelines. This inventor realised that many parts of the solution in WO 03/089833, a solution originally developed for a totally different purpose, surprisingly and advantageously also could be used in the present invention as part of the mark reading device used to identify an electrode mark.

An illuminating source providing a fan shaped beam of radiation and a two-dimensional camera for depicting the illuminated line projected onto the electrode can be utilised to generate a three-dimensional image area with marks and submarks. The electrode is moved relative to the electrode mark reading device. Numerical code is extracted from said three-dimensional image.

An illuminating source providing a fan shaped beam of radiation and a one-dimensional camera depicting the illuminating line in the illuminated region of the electrode can be used to generate a two-dimensional image of the electrode area with marks and submarks when the electrode is being moved relatively to the mark reading device or when the mark reading device scans the electrode. Movement means could thus be arranged for moving the radiation unit 420 relative to the electrode 100. Either the radiation unit or the electrode itself could be moved. Numeric code is extracted from said two-dimensional image. The above movements could possibly be performed manually with portable apparatus parts.

In one alternative the light source of the electrode mark reading device illuminates the target or object to be examined with a collimated beam of light and a sensor measures the corresponding reflectivity of the part of the electrode which the collimated beam is incident on. The light source and the sensor could be scanned across the mark area for recording an image of the mark from which a numeric code can be extracted.

The source of illumination is in one alternative a laser. In the normal case the laser light a wall inside a hole will not be visible to a camera at an angle with respect to the plane of incidence of the laser light because the wall of the hole creates a shadow. This will provide absent or dark images of the holes and these may be detected. If the holes are partly filled, it will be possible to measure the depth of the 3D-images and find out if there is a hole or not.

As an alternative the electrode reading device or apparatus can be realized using an electromagnetic radiation source and a corresponding electromagnetic sensor, detector or camera.

Yet another alternative is to provide the electrode reading device with an acoustic radiation source and a corresponding acoustic sensor, detector or camera to register the relevant electrode surface topology parameters.

In order to extract a numeric code from acquired two- or three-dimensional images there is provided an image processing unit for processing the acquired images. The image processing unit comprises program modules that perform the following processing functions:
Finding the area of the mark by detecting cavities on the height data or dark areas in the image data and defining a minimum bounding box around these found areas.
Locating clearly the locations where holes are present or absent and possibly also locating the positions where some undeterminable irregularity, questionably a hole, is present.
In the event that all findings are clear a fully rule based system is used for determining the numeric code, or alternatively a statistical or classification approach is used to determine the most likely numeric code.

FIG. 3 shows a side view of the electrode 100 and the light source 420 having a fan shaped beam of light 430. In FIG. 3 it can be seen that most of the inside surface of the holes 120 will be illuminated by the beam, but for some of the holes there will be a part which is not illuminated, and which will appear dark to an observer from an point of view outside the plane of the fan of light 430.

FIG. 4 illustrates how the light beam or fan of light 430 from the light source 420 falling onto a mark region 110 appears as seen from the point of view of a camera. Outside the areas of the holes 120 a line of light will be visible, as well as inside possible hole positions where there are no holes provided, also called empty hole positions 121. In the positions where there are physical holes 120 the line will largely disappear.

FIG. 5 also illustrates how the fan shaped light beam 430 appears from the point of view of the camera 450. The line is visible at no-hole-locations 121 and between hole locations. Where there are actual holes 120 present the line is normally substantially invisible, whereas for the abnormal case of partly dirt/debris filled holes 122 the line will be at least partly visible, but the illuminated line of light may have some form of irregularity such as a bump in its curve. A bump on a line or a missing line segment indicate the presence of a hole 120.

FIG. 6 illustrates cleaning means 600 for the cleaning of holes 122 which could be at least partly filled or covered by dust, debris or dirt. The cleaning means 600 could comprise brushes 650 and one or more nozzles 620 emitting a stream of a pressurised medium 610, typically a fluid or gas, preferably compressed air, towards the electrode. The cleaning means based on brushes and/or pressurised fluid or gas can be arranged such that the dust or debris is removed from the mark area of the electrode before the electrode enters the electrode mark reading device. Suction devices could be included in order to reduce the dust exposure in the work environment. A purging device utilising clean air or other clean fluid can be arranged such that the purge medium stops dust from settling on dust sensitive parts of the radiation unit or the reading and decoding device, such as e.g. an entrance aperture of the sensor or camera or on an exit opening of the radiation or illumination means. The arrow on FIG. 6 illustrates how an electrode is moved along the cleaning means 600.

FIG. 7 illustrates how the electrodes 100 could be provided with rod holes 150 for coupling to a mounting rod 700. Typically the rod holes 150 will be arranged on a different face of the electrode 100 than the face where the electrode mark region is placed. The mounting rod 700 could also be provided with a rod mark region 710. This fork shaped rod is placed with its fork ends into the rod holes 150 in the electrode and can be cast using e.g. cast iron. This process may also have a varying quality. It is normally not practical to transport the electrode any substantial distance after the mounting rod is attached. An important function of such a mounting rod is to enable connection of an electrical current supply to the electrodes. The fork shaped rod should also be provided with a mark of the same type as the one on the electrode as the electrode will be “consumed” during use in the reduction cell.

The electrode is then mounted in a reduction cell together with other electrodes. Upon immersion into the bath the thermal shock may lead to the breaking up of the electrode and parts of it may fall into the melt. During use the electrode will be used up partly in the melt and partly in the gas above the melt. In order to run with larger currents some more modern electrodes may have been provided with a corrugated or profiled bottom surface in order to increase the surface area.

FIG. 8a illustrates several different configurations of the code area 110, respectively a square code area 111, a rectangular code area 112, a linear code area 113, a triangular code area 114 and a circular code area 115. Rectangular holes 116 are also shown.

FIG. 8b shows a code scheme 117 with a mark area 110 with parity holes to detect and possibly correct errors in read code due to debris or damaged marks. The main code area consists of 6 columns 0-5 and 5 rows 0-4. One additional row and one column have been added to allow the inclusion a row-wise and a column-wise parity scheme.

FIG. 8c shows a code scheme 118 with three different codes in a mark area 110 where the holes in the anode are configured to be a continuous area so that all holes are adjacent. The task of reading the code will then be to detect edges between the hole-area and the surrounding area with no holes. This implementation could make it easier to keep the part of the mark with holes free of debris.

The code area may be designed according to a code system in which each mark comprises a plurality of subsections, each subsection having a submark, where a submark corresponds to the presence or absence of a hole or any other detectable topology feature in a portion of the code area. Each submark could for example represent a binary digit relating to information associated with said electrode. A submark may comprise a recess or protrusion having properties that are distinguishable from said electrode surface portion. An assembly of submarks forming a mark could be arranged in any geometric pattern. A numeric code is thus realizable in a mark using the binary digits in the form of recesses, holes or protrusions, such as stud elements. See FIG. 9d-f. Typically the relationship between each mark section and a numeric code is a predetermined relationship, whereby each numeric code represents some form of information related to said electrode 100.

Redundancy and/or restrictions on the number of adjacent holes or studs present or absent can be introduced as part of the code system in order to make the code system more tolerant and robust to debris and mechanical defects in the mark region or area.

The code system may be based on rules which polarise the mark or combination of submarks make it unidirectional in such a way that it can clearly be established what is the up and down directions of the mark irrespective of the rotational state of the electrode. In other words a rotation of one version of a mark will never appear as identical to another version of a mark section. At present a six-by-six quadratic pattern of holes is preferred solution. Another solution would be four-by-eight rectangular pattern of holes. However, many other geometric configurations are possible.

The invention also comprises a code interpretation system, possibly realised as a part of the electrode mark reading apparatus. Part of the functionality of a code interpretation system is realised as a processing unit which is adapted to process a detection signal or image, e.g. from the camera of the reading device, in order to identify the possible presence of specific features on said electrode surface, such as e.g. holes, cavities or the like on the surface of the electrodes. In the code interpretation system, which in one embodiment will be based on a system of rules, perhaps with a storage containing a predetermined set of features, the identified features are converted into a numeric code. Non-existent codes due to read errors, polluted or damaged marks can be mapped into valid codes by table look-up, where the table defines the most likely correct code for each possible faulty code.

In the code interpretation system non-existent codes due to read errors, polluted or damaged marks can also be mapped into valid codes by limiting the possible resulting codes to the range of codes defined by those codes which have already been assigned either in a process, on that particular site or that have been previously assigned.

In the code interpretation system non-existent codes due to read errors, polluted or damaged marks can also be mapped into valid codes by using rule based or statistical classification methods. These methods take advantage of redundancy in the code system and use the state of a neighbouring submark to find the most likely and correct numeric code. As an example a level of redundancy could be utilized in the code of the mark section to identify and correct errors in the interpreted codes. As an example a condition could be set that there shall never be more than two absent holes next to each other in the x or y-direction. For a six-by-six pattern the number of possible combinations will then be reduced from 68 billion to 3.5 billion.

All valid marks and patterns as well as a look-up table providing a link between each of the set of all possible faulty codes and the most likely correct code could be stored in tables in memory modules.

Rules with regards to number of adjacent holes or lack of holes could make it easier to establish where the mark area 110 is located as well as make it possible to detect and even correct errors. However, this could be regarded as part of the coding system and the coding system could use all suitable approaches used for data transmission links as well as data storage.

One simple example based on parity checking will be described in the following. FIG. 8b shows a code system 117 with a mark area 110 where the possible hole positions are located in a 7×6 matrix. The basic code area is 6×5 in size and one row and one column have been added to allow column- and row-wise parity hole positions. Assume that each hole represents a binary digit “1” and the lack of a hole in a possible hole position represents a binary “0”. Let aᵢⱼ denote the binary value of column i and row j. In the code system 117 of FIG. 8b there are 7 columns (0-6) and 6 rows (0-5).

The parity hole positions or parity bits will be located in row 5 and column 6. The parity bit will be the sum of the row or the sum of the column modulo 2, i.e., the result will be 0 if the sum is even and 1 if the sum is odd. The parity bits for the columns will then be:
a₀₅=mod 2(a₀₀+a₀₁+a₀₂+a₀₃+a₀₄)
a₁₅=mod 2(a₁₀+a₁₁+a₁₂+a₁₃+a₁₄)
. . .
a₅₅=mod 2(a₅₀+a₅₁+a₅₂+a₅₃+a₅₄)
And, correspondingly, for the rows:
a₆₀=mod 2(a₀₀+a₁₀+a₂₀+a₃₀+a₄₀+a₅₀)
a₆₁=mod 2(a₀₁+a₁₁+a₂₁+a₃₁+a₄₁+a₅₁)
. . .
a₆₄=mod 2(a₀₄+a₁₄+a₂₄+a₃₄+a₄₄+a₅₄)
Finally the a₆₅ will be the sum of the parity bits modulo 2.
a₆₅=mod 2(a₀₅+a₁₅+a₂₅+a₃₅+a₄₅+a₅₅+a₆₀+a₆₁+a₆₂+a₆₃+a₆₄)

FIG. 8b, 117:2 show a practical implementation of the two-dimensional parity scheme for a selected example.

We see that a₆₀=a₆₁=a₆₂=0 and that a₆₃=a₆₄=1. For the column parity a₀₅=a₁₅=1 and that a₂₅=a₃₅=a₄₅=a₅₅=0. The parity for the parity bits, a₆₅=0.

In FIG. 8b, 117:3 shows the same mark area as 117:2 where one of the holes has been filled with debris so that the code read back will result in a₃₃=0 instead of the correct value a₃₃=1. By recalculating the parities we get corresponding values for all parity bits except a₃₅ and a₆₄. The calculated values from the code read back from 177:3 gives a₃₅=1 and a₆₃=0 where the expected results are a₃₅=0 and a₆₃=1. Assuming that there is one single fault (not multiple faults), we can establish that there is a fault in row 3 and in column 3, i.e., a₃₃ has a wrong value. It should be 1 (hole) and not 0.

This above explanation is intended to illustrate one simple example of how errors in the read data could be detected and corrected. However, any method that could be adapted to this marking system and that are known to people skilled in data storage, data transmission and signal processing technology could be used.

The electrode marking device could be of any type which is capable of changing the surface topology, such as to make indentations or other changes on the electrode that can be detected by optical, acoustic or electromagnetic methods. The said changes could be denoted submarks. Different submarks grouped together to make unique codes in certain patterns where submarks are either present or absent.

The submarks can be generated using a drill, a chisel, by sandblasting, high pressure water cutting, laser cutting or by any other method capable of changing the surface topology, removing matter or machining the surface in any known manner.

FIG. 9 shows different shapes of holes/recesses as well as protrusions. FIG. 9 a) shows milled holes 125 while FIG. 9 b) shows drilled holes 126. Recesses in FIG. 9 c) are possibly piston formed holes 127. All hole types 125, 126, 127 in FIG. 9 a-c) could also be milled.

FIG. 9 d) shows protrusions with circular, polygon shaped or similar cross section 145. FIG. 9 e) shows protrusions with conical, pyramid formed or similar shape 146. FIG. 9 f) shows protrusions with rounded corners.

Sub-marks based on recesses 120 as well as sub-marks with no recess 121 are indicated on 9 a-c).

Sub-marks based on protrusions 140 and sub-marks with no protrusion 141 are indicated on 9 d-f).

FIG. 10 illustrates an electrode marking device 300 based on pistons 360 being forced into the electrode in the moulding or vibration forming process. Pistons 360 are pressed into the coke/pitch mixture through a wall 363 of a vibration forming part of the marking device 300. The marking pistons 360 may be operated by hydraulic cylinders 355 and pistons 350 via hydraulic tubes 356. Hydraulic pressure in the individual pistons could be regulated via valves via a computer based control system that applies the proper unique code for the electrode in question.

FIG. 11 shows one implementation of an electrode marking unit 300. A drill jig 315 is capable of movement in the Z-direction 320, i.e. in a direction generally parallel to the depth of the holes, and in the Y-direction 310, i.e. in a direction generally perpendicular to the direction of the depth of the holes (up/down in FIG. 11). The conveyor belt 200 is controlled by a control system having electrode position detecting means for detecting the actual position of the electrode. Sensors could be arranged in order to register the position of the electrode on the conveyor belt. A drill or chisel 305 is driven by a drilling machine. The drill could be controlled by a robot unit, for example with control in the y and z-directions whereas the x-direction is fixed by a conveyor. For increased capacity a multiple of drills could be arranged at different heights in a pipeline configuration.

FIG. 12 shows another implementation of a marking unit 300. This implementation is based on several drills each placed at a different height to enable a pipelined drill pattern. Each drill has only movement in the Z-direction. If the required electrode mark requires a hole in some position, the conveyor belt has to be stopped in order that the electrode spot to be drilled is facing a drill 305 which has the correct position for drilling a hole at the desired position on the electrode.

FIG. 13 shows yet another implementation of a marking unit 300, adapted for drilling holes in a circular pattern. The drill system 305,310 is rotating around a drill axis 335. The electrode will be in a fixed position when the marking system operates. In addition to the circular movement there is movement in the Z-direction.

FIG. 14 shows a schematic diagram of the production flow in an electrode manufacturing plant. Raw materials such as e.g. coke 1020, pitch 1010 and additives are received and stored locally. Pitch quality data 6010 as well as coke quality data 6020 are sent to the computer based control and database system 1500 for registration and storage. The raw materials are put into a mixer 1000 and mixing process data 6030 are sent to the control and database system 1500. The mixed raw materials are put into the vibration former 1100 where the electrode is shaped. Process data 6040 from the vibration forming process is fed to the control and database system 1500.

After vibration forming the electrodes 100 are moved to the marking unit 300. The marking unit 300 requests a new and unique number 6050 from the control and database system 1500. This number is converted either in the control and database system 1500 or in the marking unit 300 into information defining the pattern of a corresponding electrode mark. The marking unit 300 then uses this information to create the mark on said electrode, by any suitable machining process e.g. by stamping pistons into the electrode during manufacture, by boring, water cutting, sandblasting or any other method which will be apparent to those skilled in the art. The electrode is now moved to a first electrode mark reader device 400 for confirmation 6060 that the electrode mark is legible to the mark reader device 400 and that the read mark can be transmitted to the control and database system 1500 and may be converted to a number which correctly identifies the electrode 100. Immediately after this reading step, the electrode 100 will be positioned in the baking furnace 2000 and the position for each electrode will be stored together with process data 6070 from the furnace 2000 in the control and database system 1500. When the baking process is completed, the electrodes 100 will be taken out and sent to a second electrode reading device 400 to again confirm 6080 that the electrode mark is legible to a mark reader device 400 and that the read mark can be transmitted to the control and database system 1500 and there may be converted to a number which correctly identifies the electrode 100. Then the electrode is transferred to a quality control section 3000 for generating quality information 6090. Quality information 6090 related to each electrode will be sent to the control and database system 1500. Electrodes 101 with inferior quality will be sent to a scrap yard 3100. Good electrodes will be sent to a storage 4000 and possibly to a shipment area 5000 where the electrodes are registered using an electrode mark reading device 400 and information on electrode number versus storage location is stored both when electrodes are put on stock and taken from storage 4000. Information on electrodes that are being shipped is also registered. Electrode storage and shipment information 6100 is exchanged with the control and database system 1500.

Process data and other data related to individual electrodes and batches of electrodes are stored in said control and database system. In the information system the data will be linked to unique codes related to each electrode.

Data stored in and handled by said control and database system 1500 could comprise data related to any combination of, but not necessarily limited to, the following data: origin and characteristics of raw materials, mixing process, forming process, baking process, quality control results, impregnation, transport and storage, mounting of rod with stubs, reduction cell position, reduction cell performance and electrode or cell irregularities and lifetime.

In control and database system the stored process information on electrode life is utilised using a rule based or statistical method approach in order to identify and scrap electrodes that are likely to fail during use in a reduction cell, to avoid irregularities and save cost.

In the control and database system the stored process data can be used as features. Information on good and bad electrodes is used as a learning set for statistical methods in order to be able to classify electrodes in any step of the production as good or bad. This will help to avoid use of potentially defective electrodes. The statistical methods could typically be one or more of many available methods using e.g. classification trees, neural networks or any other statistical method.

FIG. 15 shows the control and database system 1500 and a system 1550 for converting an anode serial number to a mark section 110 with appropriate holes or sub-marks based on other forms of topology features. The conversion system 1550 could be either fully or partly integrated in 1500 or be a part of the marking device 300. We will in the following assume that we use the mark code configuration 117 shown in FIG. 8b, but the procedure will be similar for all other coding schemes.

The control and database system 1500 has acquired process data 6010, 6020, 6030 and 6040 corresponding to the anode to be marked next. The control and database system sends the next unique serial number 6050 to the encoding unit 370 and rule storage unit 373, which generates the next legal numeric code corresponding to the serial number 6050. For code scheme 117 this number is a 30 bits integer. The resulting number 6052 is generated by increasing the input number 6050 until it fulfils the rules stored in the rule storage unit 373. The 30 bit integer is split into 5 rows of 6 bits each, the MSB bits to the left on the top row. These 5 rows are regarded as a matrix of 6×5 binary digits. Rules with regards to maximum numbers of adjacent ones and zeros are applied, if the number does not pass the test, the number is increased.

When a valid number 6052 is found, this number is sent back to the control and database system and stored there together with associated process parameters and the serial number 6050.

The mark generation unit 376 gets the valid number 6052 as input and expands the 30 bits number into an 6×5 matrix of binary digits. This matrix is identical to the matrix used in the calculations in the rule storage unit 373. Then one new row is added to the bottom of the matrix and one new column is added to the right to allow for parity bits. Column-wise and row-wise parity are added based on calculations described in the text. A parity bit for the parity row and the parity column will be put in the lower right position.

After the new 7×6 matrix 6056 has been completed, it will be sent to the marking device 300 that will make the physical mark on the anode. The marking device 300 has built-in means to position sub-marks in accordance with matrix 6056 and physical rules regarding distances and positions on the anode stored in the marking device 300.

FIG. 16 shows the details of the reader and decoder system that typically will be part of the reader 400 or part of the control and database system 1500.

The camera will be started by a sensor that detect the presence of an anode 100 on the conveyor belt 200 or it will detect the presence of the anode by analyzing the images it acquires. An external detector might be a photocell or an electromechanical switch.

The camera 450 will acquire an electronic image 6061 of the anode and store that in memory in the camera control electronics 470. The acquired image 6061 will be sent to a part of the reader electronics 472 that finds and isolates the mark area 110 in the image of the anode. The mark area of the image 6062 will be sent to the mark decoder unit 474 that converts the image of the mark section into a matrix of binary numbers 6063. The mark decoder unit 474 could be based on both the plain image and the 3D image features as described in the text. The mark decoder could also output optional information from the decoding process that might help error correction at a later stage.

Before error correction the matrix could be sent to an optional mark polarity checker 476. This checker will rotate or mirror the matrix using properties of the mark coding to establish up and down of the matrix corresponding to the code.

A polarity-corrected matrix 6064 is then sent to the error detection unit 478 of the reader system. If the error detection unit detects an error in the code, it will be sent to the error correction unit 480. If the error correction unit 480 finds that it is impossible to correct the code it will give the reader the information that it should re-read the mark on this anode or ask for manual intervention.

A correction or correct matrix will be sent to the code interpretation unit 482 that converts the correct matrix 6065 into the corresponding number 6066. The decoded number will then be sent to the control and database system 1500 for storage and association with other data referring to this electrode.

Reference is now made to FIG. 17 where multilevel code marks are explained.

In the preceding text a binary code mark system has been described i.e., hole/no-hole code marks. A hole could represent a binary “1” and no hole represent a binary “0”. An opposite coding is also possible.

A hole-based digital code mark system where the holes could have different depths is also possible each depth representing a digital value. This multilevel digital code mark system could in its simplest embodiment have 3 levels, “no hole” 131, a “shallow hole” 132 or a “deep hole” 130. This is shown in FIG. 17. More than 3 levels are also possible, but it could be more difficult to discriminate between different levels the higher the number of levels is.

The different levels could be materialized not only as different depth, but also as different diameters of the holes or different volumes of the hole or recess and combinations thereof. Thus, while FIG. 17a) shows a three-level sub-mark based on different depth/height, FIG. 17b) shows sub-marks based on different diameter and FIG. 17c) shows sub-marks based on different total volume. FIG. 17d) shows one possible combination of diameter and depth/height for the different levels. These sub-marks could be either a hole or recess or the opposite, a stud or bulge higher than and protruding from the surrounding surface. FIG. 17e) shows one embodiment for a protrusion-based code marks system, which is the “inverted” version of what is shown in 17c).

The advantage of using 3 or more levels is that the number of holes could be reduced maintaining the number of different code mark combinations. Using a 3 level code mark system and 41 hole-positions gives more combinations than a 2 level (binary) and 64 hole-positions. The table below shows the number of combinations as a function of 2, 3 and 4 levels and 10 to 64 hole-positions.

| Holes | 2 levels | 3 levels | 4 levels |
|---|---|---|---|
| 10 | 1.02e+03 | 5.90e+04 | 1.05e+06 |
| 20 | 1.05e+06 | 3.49e+09 | 1.10e+12 |
| 30 | 1.07e+09 | 2.06e+14 | 1.15e+18 |
| 32 | 4.29e+09 | 1.85e+15 | 1.84e+19 |
| 40 | 1.10e+12 | 1.22e+19 | 1.21e+24 |
| 50 | 1.13e+15 | 7.18e+23 | 1.27e+30 |
| 60 | 1.15e+18 | 4.24e+28 | 1.33e+36 |
| 64 | 1.84e+19 | 3.43e+30 | 3.40e+38 |

Some of the multilevel embodiments might require that the bottom of the hole should be registered by its depth parameters. This applies in particular for the volume-based embodiment. For the depth-based embodiment with same-diameter holes it is required that at least (n−1) levels are visible if the total depth levels are n. This is shown in FIG. 18 c).

One binary embodiment of the 3 level multilevel approach is to use shallow holes and deep holes as sub-marks shallow holes representing a binary “0” and a deep holes representing a binary “1”. This implementation will make it easier to locate the mark section of the electrode at the cost of making more holes. Every possible hole-position has a hole or recess in this implementation.

One possible embodiment both for the binary and multilevel sub-marks is to “invert” the holes i.e., “no studs” or “studs” possibly of different height representing different levels. A “stud” in this context is a surface area or protrusion at a “higher elevation” than the normal or plain surface. These studs or bulges could be made using retractable pistons in one of the walls of the vibration former. A non-retracted piston producing “no stud” while a retracted piston producing a stud. However these studs could be less robust with regards to mechanical impacts than embodiments based on holes or recesses.

Image correction in the reading apparatus is of interest.

Using sheet-of-light imaging as indicated in FIGS. 2-5 and in FIG. 18, image correction could be done using the height information. This imaging configuration giving both images and profiles (3D information). Assuming an electrode has been somewhat rotated on the conveyor belt 200 (FIG. 1) and is passing by the reader device 400. The different parts of the code mark section could then be imaged at different distances leading to a trapezoid or four sided polygon shaped code mark section. This could be corrected using the profile or height information from the 3D part of the imaging system. Image “warping” or correction could then be performed based on the distance information and specification of optical components i.e., lenses.

More particularly FIG. 18 a) shows how parts of the fan-shaped beam 430 could look from the camera point of view. The laser line in the intersection between the electrode surface and the fan shaped beam appears to be at a lower level in shallow holes 132 and at an even lower level in deep holes 130. The light line is at the highest level between sub-mark positions and in the “no-hole” areas 131.

FIG. 18 b) shows the camera sensor and the image formed on the sensor using a three-level system where the light line is visible for the camera in the bottom of all holes. The image/sensor has been turned upright. The image formed of the line 461 on the sensor 460 has three levels: “no recess” 463, “shallow hole” 464 and “deep hole” 465.

FIG. 18 c) shows the cameras sensor 460 and the image formed 462 on the sensor using a three level system where the light line is visible for the camera only in areas with no recess 131 and shallow holes 132. For the deepest holes 130 the line is not visible due to the geometry.

As being apparent from the above description the code mark section 110 is the area of the electrode 100 containing surface topology features constituting the code mark. The code mark section is built of sub-marks 120-122, 130-132 each sub-mark representing a digital digit. The sub-mark could be formed either by removing or adding matter to the area and the reading of the sub-mark could be based on detecting the presence or depth of a hole or recess as well as the height of a stud/bulge. The detection of a sub-mark could also be based on the measurement of the diameter or volume of the hole/recess or stud.

An alternative way to imprint the code mark on the electrode is to create recesses on all sub-mark positions in the vibration forming process and fill some of these with a substance compatible with the electrode material in the marking device 300. This substance possibly a coke/pitch mixture. The marking device will then fill recesses with substance according to the unique code number that should be related to this particular electrode. This approach will reduce the machining effort of the marking device.

A similar method for protrusion type (stud/bulge) sub-marks is to create studs or bulges during vibration forming for all sub-mark positions and then remove the studs/bulges appropriate to create the correct code mark number.

FIG. 19 shows pre-formed recesses (a) and protrusions (d) for all sub-mark positions. One row of the code mark is shown.

In FIG. 19 b) recesses that according to the unique code assigned to the electrode should are being filled with a substance compatible with the coke pitch mix. The device used for filling recesses, is numbered 361. FIG. 19 c) shows the final result.

In FIG. 19 e) some of the protrusions are mechanically machined off using an automatic tool 362 controlled according to the unique code mark that should be assigned to the electrode. FIG. 19 f) shows the final result. The protrusions are somewhat exaggerated to illustrate the principle more clearly. The protrusions could have any shape and any technique could be used to remove excess protrusions like, but not limited to chiselling, milling, grinding, drilling etc.

Some aluminium production facilities do not produce electrodes themselves. If they buy electrodes with marks, they will be able to use an electrode mark reading device and not an electrode marking device. It may therefore be important to provide an arrangement for communicating data from the user of the electrodes to the producer, i.e. a feedback system. Some manufacturers of electrodes will be independent, while others may not be independent. The electrode manufacturer will normally need an electrode marking device, but also an electrode mark reading device.

The invention thus also constitutes an electrode information system for an electrode for use in industrial processes. The electrode information system has an encoding and marking device for providing said electrode with an electrode specific mark and a mark reading and decoding device for identifying possible mark(s) on said electrode. The electrode information system could be adapted, for example by including an association module, for associating said mark(s) with electrode specific information and thereby for creating a link between said mark(s) and information related to said electrode.

In one aspect of the invention the electrode mark reading device for obtaining information related to an electrode is realised without a radiation unit, thus being formed by the combination an imaging unit, a decoding unit and conversion means. The imaging unit provides an image of at least a part of said electrode. The decoding unit is adapted to transform said image into a decoded signal, a part of which is related to a mark on said electrode. A converter converts the decoded signal into an electrode code, where said electrode code represents a feature related to said electrode.

In another aspect of the invention the electrode mark reading device for obtaining information related to an electrode comprises an imaging unit and a code interpretation unit. The imaging unit obtains an image of at least a part of said electrode and a code interpretation unit interprets said image in order to find and interpret marks in a mark section on at least a part of the electrode 100 appearing on said image. The imaging unit thus obtains a code representing said mark section.

A major benefit obtained with this invention is the possibility to trace each electrode from its manufacture to its end destination, for example a reduction cell in a pot room in a smelter.

### LIST OF REFERENCE NUMERALS USED

Number Description

100 Electrode, anode etc.
101 Scrapped electrodes
110 Code mark section, area with code mark
111 N×N sub marks
112 N×M sub marks
113 N×1 sub marks
114 Triangular sub sub-mark section
115 Circular sub mark section
116 N×1 square sub-marks
117 6×5 plus parity, 7×6 total
118 Mark with continuous hole section
120 Hole, sub-mark
121 Hole sub mark position, no hole
122 Hole, partly filled with debris
125 Holes, cylindrical
126 Holes, drilled, standard
127 Holes, rounded corners
130 Deepest hole, 3 level system
131 Hole position, no hole, 3 level system
132 Shallow hole, 3 level system
135 Sub-mark, largest protrusion, multilevel protrusions
136 Sub-mark, no protrusion, multilevel protrusions
137 Sub-mark, medium protrusion, multilevel protrusions
140 Sub mark, protrusion
141 Sub mark, no protrusion
145 Protrusion, cylindrical, box-shaped etc
146 Protrusion, conical, pyramid shaped etc
147 Protrusion, smoothed corners
150 Mounting holes for rod with stubs
200 Conveyor belt
300 Marking device/apparatus
302 Multiple drill unit arrangement, matrix, pipeline drill operation
303 Rotating drill arrangement
305 Drill or chisel
310 Drill unit
315 Drill jig
320 Means for movement in Z-direction
335 Rotating axis for 303
350 Hydraulic piston
355 Hydraulic cylinder
356 Hydraulic tube
360 Marking Piston
361 Recess filling device
362 Protrusion removal device
363 Wall of vibration former
370 Encoding unit
373 Rule storage unit
376 Mark generation unit
400 reading device/apparatus
420 Radiation source, preferably laser
430 Fan shaped beam, preferably laser beam
450 Camera, preferably with 2 D sensor
455 Camera field of view
456 Field of view, obstructed by wall of hole
460 Camera sensor, 2 D
461 Image of laser line formed on sensor, 3 level holes, all levels visible
462 Image of laser line formed on sensor, 3 level holes, level 0 and 1 visible, 2 not visible
463 Radiation line or image thereof, no hole
464 Radiation line or image thereof, shallow hole
465 Radiation line or image thereof, deep hole
470 Camera control electronics
472 Reader electronics, isolates mark section of image 6061
474 Mark decoder unit
476 Mark polarity checker
478 Error detection unit
480 Error correction unit
482 Code interpretation unit
600 Cleaning device
610 Cleaning medium, preferably compressed air
620 Nozzle, cleaning medium
650 Brushes
700 Rod with stubs
710 Mark on rod with stubs
1000 Mixer, mixing coke and pitch as well as additives
1010 Pitch
1020 Petroleum coke
1100 Vibration former
1500 Control and database system
1550 Conversion system, serial numbers vs. code marks
1600 Computer hardware and storage media
2000 Baking furnace
3000 Quality control area or section
3100 Scrap yard
4000 Storage area
5000 Transport and shipment area
6010 Pitch data
6020 Coke data
6030 Mixing data
6040 Vibration former data
6050 Data to and from marking device
6052 Valid number to be applied on electrode
6056 Valid code mark
6060 Data from reader, read back
6061 Electronic image of anode
6062 Mark area of image 6061
6063 Matrix of binary numbers
6064 Polarity corrected matrix
6065 Correct matrix
6066 Resulting number from matrix 6065
6070 Baking furnace process data
6080 Reader data, after baking
6090 Quality control data
6100 Data from distribution, transport and storage data

1-30. (canceled)

31. Electrode for use in industrial electrochemical or electrometallurgical processes typically applied in aluminium smelters, the electrodes (100) being made of raw materials comprising coke and pitch, subjected to heat treatment during manufacturing, and adapted to be consumed during use, characterised by a code pattern marking comprising at least one surface topology element in the form of a recess (120) and/or protrusion (140) with dimensions that clearly defines it relative to normal structure of the surface (110) of said type of electrode (100), and where said recess (120) and/or protrusion (140) is provided in a surface portion (110) of the electrode (100), for representing information relating to the electrode.

32. Electrode according to claim 31, wherein said recess (120) is of a magnitude of 1 cm in diameter and 1 cm in depth.

33. Electrode according to claim 31, wherein said code pattern marking comprises a mark section (110) provided within said surface portion and comprising at least one sub-mark (120/121,140/141) relating to information associated with the electrode (100).

34. Electrode according to claim 33, wherein said mark section (110) comprises a plurality of subsections and each subsection represents a binary digit, i.e. one bit.

35. Electrode according to claim 33, wherein said mark section comprises a plurality of subsections each representing one of three or more value levels (130,131,132; 135,136,137).

36. Electrode according to claim 33, wherein the arrangement of sub-marks (120) within a mark section (110) is made according to a set of rules which provides all possible arrangements of sub-marks with a unidirectional property, such that a rotation of one version of a mark will never appear as identical to another version of a mark section (110).

37. Method for marking electrodes for use in industrial electrochemical or electrometallurgical processes typically applied in aluminium smelters, the electrodes (100) being made of raw materials comprising coke and pitch, subjected to heat treatment during manufacturing, and adapted to be consumed during use,
characterised by comprising the steps of
providing (1500) information relating to specific code patterns for said marking, and
applying a device (300) to form said marking so as to comprise at least one surface topology element in the form of a recess (120) and/or protrusion (140) in a surface portion (110) of the electrodes (100), based on said information.

38. Method according to claim 37, comprising use of mechanical means such as drill (305) or pistons (360) to form said marking.

39. Method according to claim 37, wherein recesses are first formed at all sub-mark positions within said surface portion (110), and then selected ones of said recesses are filled (361) with a substance compatible with the electrode material, so as to leave at least one recess to be effective in the code concerned.

40. Method according to claim 37, wherein protrusions are first formed at all sub-mark positions within said surface portion (110), and then selected ones of said protrusions are removed (362), leaving at least one protrusion to be effective in the code concerned.

41. Apparatus for marking electrodes for use in industrial electrochemical or electrometallurgical processes typically applied in aluminium smelters, the electrodes (100) being made of raw materials comprising coke and pitch, subjected to heat treatment during manufacturing, and adapted to be consumed during use,
characterised by comprising
an information unit (1500) for providing information relating to specific code patterns for said marking, and
a marking device (300) adapted to receive said information for forming said marking so as to comprise at least one surface topology element in the form of a recess (120) and/or protrusion (140) in a surface portion (110) of the electrodes (100).

42. Apparatus according to claim 41, comprising use of mechanical means such as drill (305) or pistons (360) to form said marking.

43. Apparatus according to claim 41, comprising a rule storage unit (373) for storing a set of predetermined rules to be used for providing said marking (110) from said information.

44. Apparatus according to claim 41, comprising a mark storage unit for storing information relating to a plurality of markings (110).

45. Reading apparatus for providing information related to an electrode for use in industrial electrochemical or electrometallurgical processes typically applied in aluminium smelters, the electrodes (100) being made of raw materials comprising coke and pitch, subjected to heat treatment during manufacturing, and adapted to be consumed during use, characterised by comprising a radiation unit (420) for directing radiation towards said electrode (100) in the form of a beam having one cross-sectional dimension which is smaller than a transverse dimension of a recess (120) or protrusion (140) comprised by a code marking (110) at a surface portion of the electrode (100), in order that at least a part of the beam of radiation can impinge on said electrode (100) substantially within the boundaries of said recess (120), and detection devices sensitive to radiation reflected from said surface portion of the electrode (100).

46. Reading apparatus according to claim 45, wherein the radiation unit is adapted to provide a beam having a generally spot-shaped cross-section, the largest cross-sectional dimension of which is smaller than said transverse dimension, in order that the whole or a major part of the beam of radiation can impinge on said electrode (100) substantially within the boundaries of said recess (120) or said protrusion (140).

47. Reading apparatus according to claim 45, wherein the radiation unit (420) is adapted to provide a fan-shaped radiation beam (430) directed towards the electrodes (100).

48. Reading apparatus according to claim 45, wherein the radiation unit (420) comprises an electromagnetic radiation source, such as a laser source.

49. Reading apparatus according to claim 45, wherein the radiation unit (420) comprises an acoustic radiation source.

50. Reading apparatus according to claim 45, comprising a 2-dimensional camera (450) directed towards the electrode (100) for providing 2-dimensional images of the surface of the electrode (100).

51. Reading apparatus according to claim 50, wherein there is provided a decoding unit adapted to process 2-dimensional images of the surface of the electrode (100).

52. Reading apparatus according to claim 45, comprising a 1-dimensional camera (450) for obtaining a 1-dimensional image of the radiated area of the electrode (100), preferably with the apparatus being adapted for relative movement between the radiation unit (420) and the electrode (100).

53. Reading apparatus according to claim 45, being adapted for relative movement between the radiation unit (420) and the electrode (100).

54. Reading apparatus according to claim 45, wherein the radiation unit (420) is adapted to project a collimated beam of radiation onto the electrode (100).

55. Reading apparatus according to claim 45, comprising,
a detection unit (450) for detecting radiation reflected by or transmitted through at least a part of said electrode (100), and for converting said detected radiation into a converted signal,
a decoding unit adapted to transform said converted signal into a decoded signal, a part of which is related to a mark (110) on said electrode (100), and
conversion means for converting said decoded signal into an electrode code, thus obtaining a representation of a feature related to said electrode (100).

56. Reading apparatus according to claim 55, comprising a processing unit adapted to process said signal to identify possible presence of specific features on said electrode surface, and convert said identified features into a numeric code.

57. Reading apparatus according to claim 45, comprising a purging device (620) arranged to prevent the settling of dust on dust sensitive parts of the apparatus, such as e.g. entrance aperture of detection unit and exit opening of radiation unit.

58. Electrode information system for electrodes (100) for use in industrial electrochemical or electrometallurgical processes typically applied in aluminium smelters, the electrodes (100) being made of raw materials comprising coke and pitch, subjected to heat treatment during manufacturing, and adapted to be consumed during use,
comprising
an encoding and marking device (300) for providing said electrode (100) with a an electrode specific mark,
a mark reading and decoding device (400) for identifying possible mark(s) (110) on said electrode (100),
an association module for associating said mark(s) (110) with electrode (100) specific information and thereby for creating a link between said mark(s) and information related to said electrode (100).

59. Electrode mark reading device for obtaining information related to an electrode (100) for use in industrial electrochemical or electrometallurgical processes typically applied in aluminium smelters, the electrodes (100) being made of raw materials comprising coke and pitch, subjected to heat treatment during manufacturing, and adapted to be consumed during use, comprising,
an imaging unit (450) for obtaining an image of at least a part of said electrode (100),
a decoding unit adapted to transform said image into a decoded signal, a part of which is related to a mark (110) on said electrode (100),
conversion means for converting said decoded signal into an electrode (100) code, said electrode code representing a feature related to said electrode 100 thus being made readily available.

60. Electrode mark reading device for obtaining information related to an electrode (100) for use in industrial electrochemical or electrometallurgical processes typically applied in aluminium smelters, the electrodes (100) being made of raw materials comprising coke and pitch, subjected to heat treatment during manufacturing, and adapted to be consumed during use, comprising,
an imaging unit (450) for obtaining an image of at least a part of said electrode (100), and
a code interpretation unit for interpreting said image in order to find and interpret marks (120) in a mark section (110) on said at least part of said electrode (100) which appear on said image, and to obtain a code representing said mark section (110).

61. Electrode mark reading device according to claim 60, comprising an error identification and correction module adapted to utilize a level of redundancy in the code of the mark section (110) to identify and correct errors in the interpreted code due to mark code anomalies, caused for example by imaging errors, polluted or damaged marks.

62. Electrode mark reading device according to claim 60, comprising tables in memory modules for storing all valid marks and patterns of marks as well as a lookup-table providing a link between each of the set of all possible faulty codes the most likely correct code.

63. Electrode mark reading device according to claim 60, wherein the code interpretation unit is adapted to perform rule based or statistical classification methods in order to correct possible errors in the said code or find the code that is most probably correct.
